(19) United States
(12) Patent Application Publication
(10) Pub. No.: US 2013/0271567 A1
(43) Pub. Date: Oct. 17, 2013

(54) IMAGE PROCESSING METHOD AND APPARATUS FOR PREDICTING MOTION VECTOR AND DISPARITY VECTOR

(71) Applicant: SAMSUNG ELECTRONICS CO., LTD., Suwon-si (KR)

(72) Inventors: Jin Young LEE, Hwaseong-si (KR); Jae Joon Lee, Seoul (KR)

(73) Assignee: Samsung Electronics Co., Ltd., Suwon-si (KR)

(21) Appl. No.: 13/856,669

(22) Filed: Apr. 4, 2013

Related U.S. Application Data
(60) Provisional application No. 61/624,621, filed on Apr. 16, 2012.
(60) Provisional application No. 61/651,275, filed on May 24, 2012.

(30) Foreign Application Priority Data
Jul. 6, 2012 (KR) 10-2012-0074189

(51) Int. Cl. H04N 13/00

(52) U.S. Cl. CPC H04N 13/0048
USPC 348/43

(57) ABSTRACT

An image processing method and apparatus for predicting a motion vector and a disparity vector may include extracting a disparity vector of at least one neighboring block with respect to a current block of a color image to be coded, and predicting a disparity vector of the current block, using the disparity vector of the at least one neighboring block.

### CROSS-REFERENCE TO RELATED APPLICATIONS

This application claims the priority benefit under 35 U.S.C. §119(e) of U.S. Provisional Application No. 61/624,621, filed on Apr. 16, 2012, and U.S. Provisional Application No. 61/651,275, filed on May 24, 2012, in the U.S. Patent and Trademark Office, and the priority benefit under 35 U.S.C. §119(a) of Korean Patent Application No. 10-2012-0074189, filed on Jul. 6, 2012, in the Korean Intellectual Property Office, the entire disclosures of which are incorporated herein by reference for all purposes.

### BACKGROUND

1. Field

The following description relates to a method and apparatus for efficiently compressing and restoring a three-dimensional (3D) video, and more particularly, to a method and apparatus for predicting a motion vector and a disparity vector using a depth image corresponding to a color image.

2. Description of the Related Art

A stereoscopic image may refer to a three-dimensional (3D) image which provides shape information about a depth and a space simultaneously. Although a stereo image provides images captured from different points of view for left and right eyes, the stereoscopic image may provide an image which provides an effect similar to a viewer viewing the image from different directions each time a point of view of the viewer changes. Accordingly, images captured from multiple points of view may be required in order to generate a stereoscopic image.

The images captured from multiple points of view may include a considerable amount of data. Accordingly, although the images are compressed using an encoder optimized for single-view video coding, generating a stereoscopic image may be difficult in view of a network infrastructure, a bandwidth of a ground wave, and the like.

Accordingly, there is a desire for an apparatus for coding a multiview image that is optimized to generate a stereoscopic image. In particular, there is a need for technologies for efficiently reducing temporal redundancy and view redundancy.

### SUMMARY

The foregoing and/or other aspects are achieved by providing an image processing method, including extracting a motion vector of at least one neighboring block with respect to a current block of a color image to be coded, and predicting a motion vector of the current block, using the extracted motion vector of the at least one neighboring block.

The foregoing and/or other aspects are achieved by providing an image processing method, including extracting a disparity vector of at least one neighboring block with respect to a current block of a color image to be coded, and predicting a disparity vector of the current block, using the extracted disparity vector of the at least one neighboring block.

The foregoing and/or other aspects are achieved by providing an image processing method, including identifying a collocated block of a depth image corresponding to a current block of a color image to be coded, and predicting a disparity vector of the current block, by converting a greatest depth value of the collocated block into a disparity value.

The foregoing and/or other aspects are achieved by providing an image processing method, including identifying at least one neighboring block of a current block of a color image, and a collocated block of a depth image corresponding to the current block, determining a final vector with respect to a skip mode or a direct mode of the current block, based on the at least one neighboring block and the collocated block, and coding the current block in the skip mode or the direct mode, using the final vector of the current block.

The foregoing and/or other aspects are achieved by providing an image processing apparatus, including: a motion vector extracting unit to extract a motion vector of at least one neighboring block with respect to a current block of a color image to be coded; and a motion vector predicting unit to predict a motion vector of the current block, using the extracted motion vector of the at least one neighboring block.

The foregoing and/or other aspects are achieved by providing an image processing apparatus, including a disparity vector extracting unit to extract a disparity vector of at least one neighboring block with respect to a current block of a color image to be coded; and a disparity vector predicting unit to predict a disparity vector of the current block, using the extracted disparity vector of the at least one neighboring block.

The foregoing and/or other aspects are achieved by providing an image processing apparatus, including a collocated block identifying unit to identify a collocated block of a depth image corresponding to a current block of a color image to be coded; and a disparity vector predicting unit to predict a disparity vector of the current block, by converting a greatest depth value of the collocated block into a disparity value.

The foregoing and/or other aspects are achieved by providing an image processing apparatus, including a collocated block identifying unit to identify at least one neighboring block of a current block of a color image, and a collocated block of a depth image corresponding to the current block; a final vector determining unit to determine a final vector with respect to a skip mode or a direct mode of the current block, based on the at least one neighboring block and the collocated block; and an image coding unit to code the current block in the skip mode or the direct mode, using the final vector of the current block.

The foregoing and/or other aspects are achieved by providing an image processing method, including extracting at least one of a motion vector and a disparity vector of at least one neighboring block with respect to a current block of a color image to be coded; and predicting at least one of a motion vector and a disparity vector of the current block, using the extracted vector of the at least one neighboring block.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an operation of an encoding apparatus and an operation of a decoding apparatus according to example embodiments;

FIG. 2 illustrates an image processing apparatus according to example embodiments;

FIG. 3 illustrates an image processing apparatus according to example embodiments;

FIG. 4 illustrates an image processing apparatus according to example embodiments;

FIG. 5 illustrates an image processing apparatus according to example embodiments;

FIG. 6 illustrates a structure of a multiview video according to example embodiments;

FIG. 7 illustrates reference images to be used for coding a current block according to example embodiments;

FIG. 8 illustrates a detailed operation of an encoding apparatus according to example embodiments;

FIG. 9 illustrates a detailed operation of a decoding apparatus according to example embodiments;

FIGS. 10A and 10B illustrate a process of predicting a motion vector of a current block according to example embodiments;

FIGS. 11A and 11B illustrate a process of predicting a disparity vector of a current block according to example embodiments;

FIG. 12 illustrates a process of determining a final vector with respect to a skip mode and a direct mode of a current block according to example embodiments;

FIG. 13 illustrates a process of estimating a depth image according to example embodiments;

FIG. 14 illustrates an image processing method according to example embodiments;

FIG. 15 illustrates an image processing method according to example embodiments;

FIG. 16 illustrates an image processing method according to example embodiments; and

FIG. 17 illustrates an image processing method according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

The term “current block” refers to a block of a color image to be encoded or decoded. Herein, the term “current block” may also be referred to as “current color block.”

The term “depth image corresponding to a current block” refers to a depth image corresponding to a color image including a current block. In particular, a size of the color image may be identical to or different from a size of the depth image. Here, the size may refer to a resolution. When a size of the depth image corresponding to the current block differs from a size of the color image including the current block, the size of the depth image may be adjusted to the size of the color image. When a process of adjusting the size of the depth image to the size of the color image is absent, the size of the color image including the current block may differ from the size of the depth image corresponding to the current block. Herein, the term “depth image corresponding to the current block” may also be referred to as “corresponding depth map.”

The term “neighboring block” refers to at least one encoded or decoded block that neighbors a current block. Depending on embodiments, the neighboring block may be positioned at the top corner, the top-right corner, the left corner, or the top-left corner of the current block. Herein, the term “neighboring block” may also be referred to as “neighboring block around a current block.”

The term “collocated block” refers to a depth image block included in a depth image corresponding to a current block. When a size of a color image including the current block differs from a size of the depth image including the collocated block, a size of the current block may differ from a size of the collocated block. Herein, the term “collocated block” may also be referred to as “collocated depth block in the corresponding depth map.”

The term “compensated block” refers to a depth image block corresponding to a location indicated by a motion vector or a disparity vector of a neighboring block, based on a collocated block in a depth image. When a size of a color image including the current block differs from a size of a depth image including the compensated block, a size of the current block may differ from a size of the compensated block. Herein, the term “compensated block” may also be referred to as “compensated block based on motion vector or disparity vector.”

The term “estimated depth image” refers to a depth image that may be estimated using a neighboring color image or a neighboring depth image when a depth image corresponding to a color image including a current block is absent. When a size of the neighboring color image differs from a size of the neighboring depth image, a size of the color image may differ from a size of the estimated depth image. Herein, the term “estimated depth image” may also be referred to as “estimated depth map.”

The term “hole pixel” refers to a pixel that is undefined in an estimated depth image. Herein, the term “hole pixel” may also be referred to as “undefined pixel.”

The term “adjacent pixel” refers to a pixel positioned adjacent to a hole pixel in an estimated depth image.

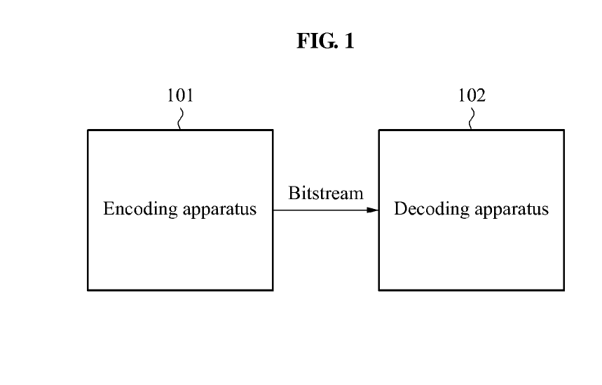

FIG. 1 illustrates an operation of an encoding apparatus 101 and an operation of a decoding apparatus 102 according to example embodiments.

Referring to FIG. 1, the encoding apparatus 101 may encode a three-dimensional (3D) video, and may transmit the encoded data to the decoding apparatus 102 in the form of a bitstream. 3D videos may have temporal redundancy between temporally successive images, and also have view redundancy between images indicating different points of views. Accordingly, the encoding apparatus 101 and the decoding apparatus 102 that are optimized for a 3D video may be used to efficiently remove temporal redundancy and view redundancy.

Accordingly, the encoding apparatus 101 and the decoding apparatus 102 may remove the most redundancy between images when a 3D video is coded, thereby increasing a coding efficiency.

The encoding apparatus 101 and the decoding apparatus 102 may perform block prediction to remove the redundancy between color images. When the block prediction is performed, a depth image may be used to efficiently remove view redundancy. Accordingly, the temporal redundancy may be removed using motion vectors of neighboring blocks, and the view redundancy may be removed using a depth image corresponding to the color image, and disparity vectors of the neighboring blocks.

Here, a size of the depth image corresponding to the color image may differ from a size of the color image. In this instance, the size of the depth image may be adjusted to be identical to the size of the color image. For example, when the size of the depth image is smaller than the size of the color image, the depth image may be up-sampled so that the size of the depth image may be adjusted to be identical to the size of the color image.

According to example embodiments, although the size of the depth image differs from the size of the color image, the original depth image may be used, without adjusting the size of the depth image. In this instance, a process of adjusting the size of the depth image is unrequested and thus, complexity may decrease and an amount of memory to be used may be reduced.

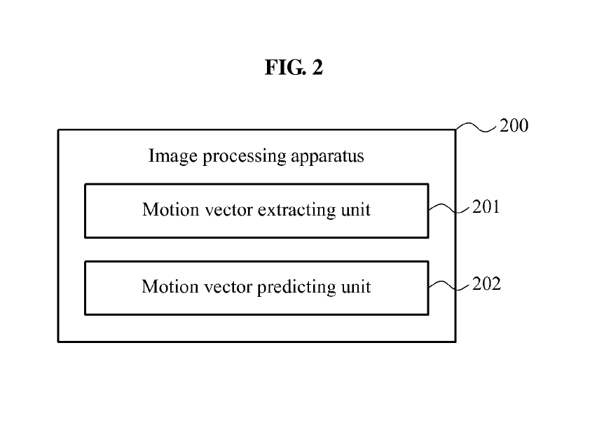

An image processing apparatus mentioned with reference to FIGS. 2 through 17 may be implemented in an internal portion or external portion of the encoding apparatus 101 or in an internal portion or external portion of the decoding apparatus 102 of FIG. 1.

FIG. 2 illustrates an image processing apparatus 200 according to example embodiments.

Referring to FIG. 2, the image processing apparatus 200 may include a motion vector extracting unit 201 and a motion vector predicting unit 202.

The motion vector extracting unit 201 may extract a motion vector of at least one neighboring block with respect to a current block of a color image to be coded. For example, when a motion vector of the at least one neighboring block is absent, the motion vector extracting unit 201 may replace the motion vector of the at least one neighboring block with a zero motion vector. Here, the neighboring block may refer to an encoded or decoded block neighboring the current block at the top corner, the top-right corner, or the left corner of the current block, in the color image. When a neighboring block is absent at the top-right corner of the current block, the motion vector extracting unit 201 may use a neighboring block positioned at the top-left corner of the current block.

The motion vector predicting unit 202 may predict a motion vector of the current block using the motion vector of the at least one neighboring block. For example, the motion vector predicting unit 202 may predict the motion vector of the current block by applying a median filter to the motion vector of the at least one neighboring block.

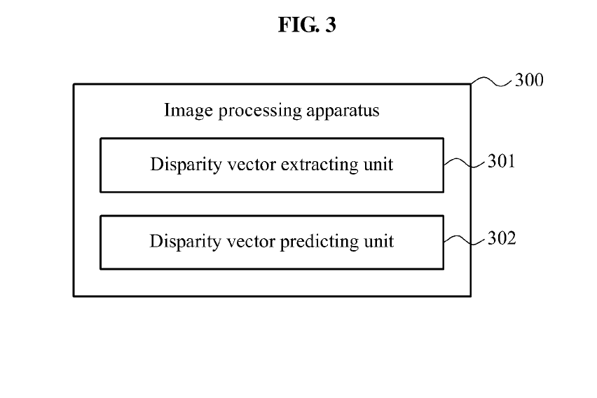

FIG. 3 illustrates an image processing apparatus 300 according to example embodiments.

Referring to FIG. 3, the image processing apparatus 300 may include a disparity vector extracting unit 301 and a disparity vector predicting unit 302.

The disparity vector extracting unit 301 may extract a disparity vector of at least one neighboring block with respect to a current block of a color image to be coded. Here, the neighboring block may refer to an encoded or decoded block neighboring the current block at the top corner, the top-right corner, or the left corner of the current block, in the color image. When a neighboring block is absent at the top-right corner of the current block, the disparity vector extracting unit 301 may use a neighboring block positioned at the top-left corner of the current block.

For example, when a disparity vector of the at least one neighboring block is absent, the disparity vector extracting unit 301 may extract the disparity vector of the at least one neighboring block using a collocated block of a depth image corresponding to the current block. In particular, when a disparity vector of the at least one neighboring block is absent, the disparity vector extracting unit 301 may replace the disparity vector of the at least one neighboring block with a disparity vector converted from a greatest depth value of the collocated block of the depth image corresponding to the current block. Here, the collocated block may include a block positioned at an identical location of the current block, in the depth image corresponding to the color image. In addition, a size of the depth image corresponding to the current block may be the same as a size of the color image, or the size of the depth image may differ from the size of the color image.

When a depth image corresponding to the current block is absent, the disparity vector extracting unit 301 may estimate a depth image corresponding to the current block using a neighboring depth image or a neighboring color image of the color image including the current block. In this instance, the disparity vector extracting unit 301 may replace a hole pixel undefined in the estimated depth image with an adjacent pixel having a greatest pixel value, among adjacent pixels. As another example, the disparity vector extracting unit 301 may replace a pixel value of the hole pixel undefined in the estimated depth image corresponding to the current block with an interpolation value obtained by interpolating the adjacent pixels of the hole pixel.

The disparity vector predicting unit 302 may predict a disparity vector of the current block, using the disparity vector of the at least one neighboring block.

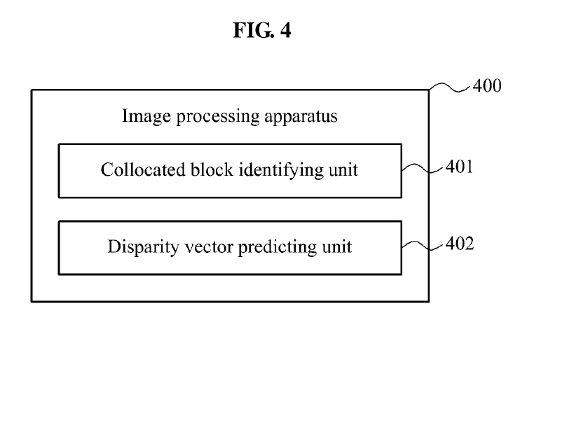

FIG. 4 illustrates an image processing apparatus 400 according to example embodiments.

Referring to FIG. 4, the image processing apparatus 400 may include a collocated block identifying unit 401 and a disparity vector predicting unit 402.

The collocated block identifying unit 401 may identify a collocated block of a depth image corresponding to a current block of a color image to be coded. For example, the collocated block identifying unit 401 may identify a collocated block of the depth image corresponding to the color image.

When a depth image corresponding to the current block is absent, the collocated block identifying unit 401 may estimate a depth image corresponding to the current block, using a neighboring depth image or a neighboring color image of the color image including the current block. In this instance, the collocated block identifying unit 401 may replace a hole pixel undefined in the estimated depth image corresponding to the current block with an adjacent pixel having a greatest pixel value, among adjacent pixels. As another example, the collocated block identifying unit 401 may replace a pixel value of the hole pixel undefined in the estimated depth image corresponding to the current block with an interpolation value obtained by interpolating the adjacent pixels of the hole pixel.

The disparity vector predicting unit 402 may predict a disparity vector of the current block, by converting a greatest depth value of the collocated block of the depth image into a disparity value.

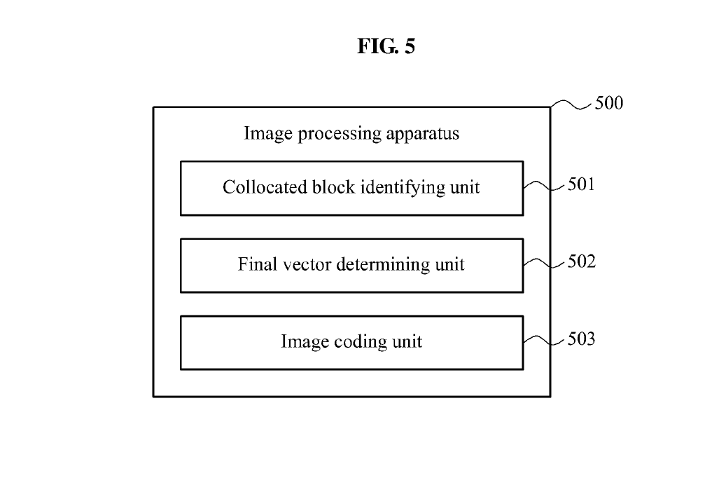

FIG. 5 illustrates an image processing apparatus 500 according to example embodiments.

Referring to FIG. 5, the image processing apparatus 500 may include a collocated block identifying unit 501, a final vector determining unit 502, and an image coding unit 503.

The collocated block identifying unit 501 may identify at least one neighboring block of a current block of a color image, and a collocated block of a depth image corresponding to the current block.

The final vector determining unit 502 may determine a final vector with respect to a skip mode or a direct mode of the current block, using the at least one neighboring block and the collocated block. For example, the final vector determining unit 502 may determine compensated blocks, based on a motion vector or a disparity vector of the at least one neighboring block, in the collocated block. The final vector determining unit 502 may compare a depth value of the collocated block to depth values of respective compensated blocks. The final vector determining unit 502 may convert differences between the depth value of the collocated block and the depth values of respective compensated blocks into disparity differences, and may use a motion vector or a disparity vector of a corresponding neighboring block having a smallest disparity difference, among the disparity differences.

The image coding unit 503 may code the current block in the skip mode or the direct mode, using the final vector of the current block.

The operations of the image processing apparatuses have been described according to example embodiments.

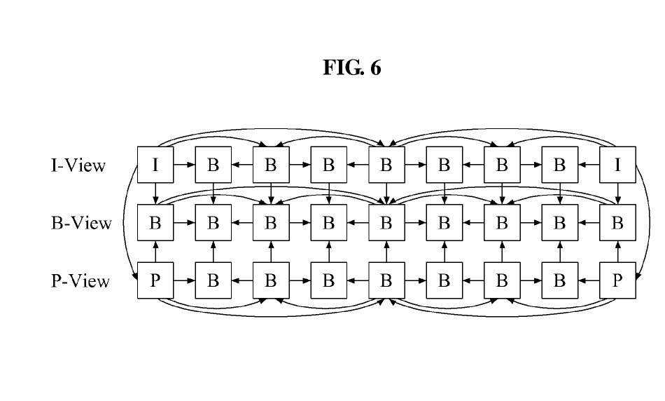

FIG. 6 illustrates a structure of a multiview video according to example embodiments.

Referring to FIG. 6, when three view images, such as a left view image, a center view image, and a right view image, for example, are input, multiview coding may be performed to encode the three view images into a group of pictures (GOP) “8.” Because a hierarchical B picture may be basically applied to a temporal axis and a view axis in order to encode a multiview image, redundancy between images may be reduced.

In the structure of the multiview video of FIG. 6, the encoding apparatus 101 of FIG. 1, that is, a multiview video encoding apparatus, may encode a left picture corresponding to an I-View, a right picture corresponding to a P-View, and a center picture corresponding to a B-View, sequentially, thereby encoding the images corresponding to three points of view.

In this instance, the left picture may be encoded using a method of removing temporal redundancy by searching for a similar area in previous images through motion estimation. The right picture may be encoded using a method of removing view redundancy through disparity estimation and removing temporal redundancy through motion estimation because the right picture may be encoded using the already encoded left picture as a reference picture. In addition, because the center picture may be encoded using the already encoded left picture and the already encoded right picture as reference pictures, view redundancy may be removed from the center picture through disparity estimation in both directions.

Referring to FIG. 6, in multiview video coding (MVC), an image that is encoded without the use of a reference image corresponding to another point of view, such as the left picture, for example, may be defined as I-View. An image that is encoded by predicting, in a single direction, a reference image corresponding to another point of view, for example, the right picture, may be defined as P-View. An image that is encoded by predicting, in both directions, reference images corresponding to left and right points of view, for example, the center picture, may be defined as B-View.

In the MVC, frames may be classified into six groups, based on prediction structures. In particular, the six groups may include an I-View anchor frame for intra coding, an I-View non-anchor frame for inter coding between temporal axes, a P-View anchor frame for unidirectional inter coding between points of view, a P-View non-anchor frame for unidirectional inter coding between points of view and bidirectional inter coding between temporal axes, a B-View anchor frame for bidirectional inter coding between points of view, and a B-View non-anchor frame for bidirectional inter coding between points of view and bidirectional inter coding between temporal axes.

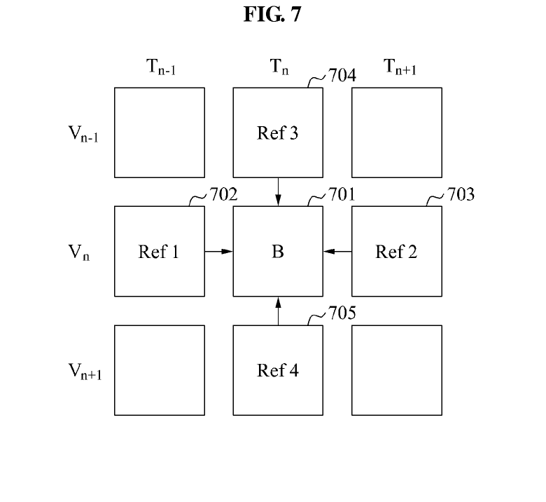

FIG. 7 illustrates reference images to be used for coding a current block according to example embodiments.

An image processing apparatus may compress a current block positioned in a current frame corresponding to a current image 701, using a first reference image 702 and a second reference image 703 that are positioned adjacent to the current frame in terms of time, and a third reference image 704 and a fourth reference image 705 that are positioned adjacent to the current frame in terms of point of view. In particular, the image processing apparatus 100 of FIG. 1 may compress a residual signal between the current block and a predictive block by searching for the predictive block most similar to the current block in the first reference image 702, the second reference image 703, the third reference image 704, and the fourth reference image 705. In a case of H.264/advanced video coding (AVC), compression modes for searching for a predictive block using reference images may include a SKIP (P Slice Only) mode, a Direct (B Slice Only) mode, a 16×16 mode, a 16×8 mode, an 8×16 mode, a P8×8 mode, and the like. In a case of high efficiency video coding (HEVC), compression modes may include a 2N×2N mode, a 2N×N mode, an N×2N mode, an N×N mode, and the like.

The image processing apparatus may use the first reference image 702 and the second reference image 703 to search for motion information, and may use the third reference image 704 and the fourth reference image 705 to search for disparity information.

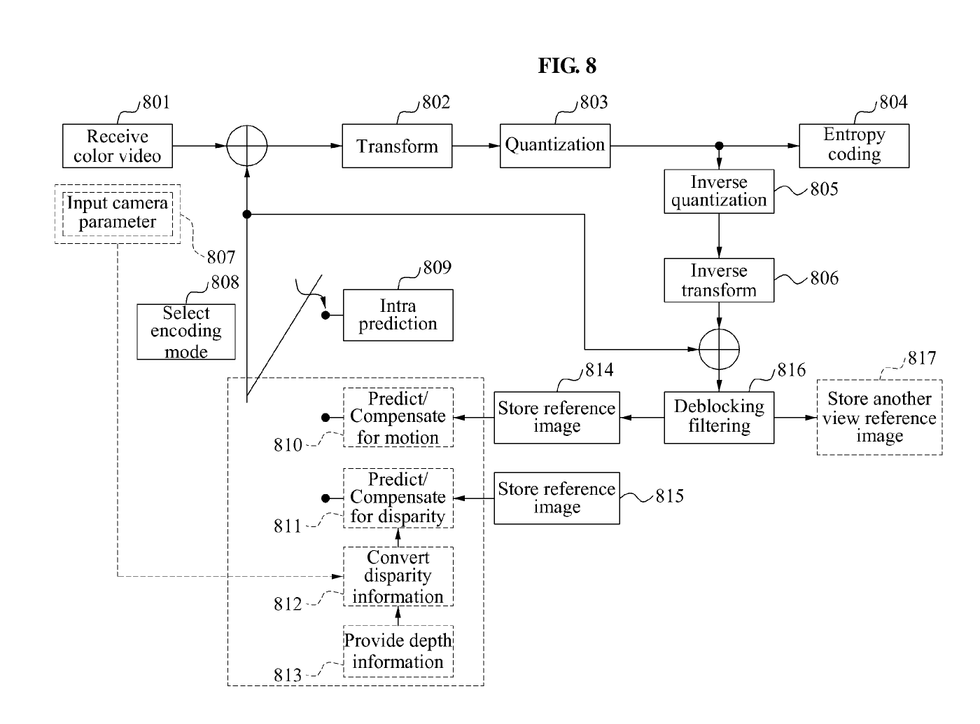

FIG. 8 illustrates a detailed operation of an encoding apparatus according to example embodiments.

Referring to FIG. 8, an apparatus for encoding a color image is illustrated. In FIG. 8, the image processing apparatus may perform motion vector prediction and disparity vector prediction.

A process of encoding the color image may be performed by the encoding apparatus. The encoding apparatus may receive a color image in operation 801, and may determine a residual signal between the color image and a predictive image derived through block prediction. The encoding apparatus may transform the residual signal in operation 802, and may quantize the transformed residual signal in operation 803.

The encoding apparatus may entropy code the quantized signal in operation 804, perform an inverse quantization of the quantized signal in operation 805, and inverse transform the inverse quantized signal in operation 806. In operation 816, the encoding apparatus may perform deblocking filtering based on the inverse transformed signal and the predictive image, and store a reference image in operations 814, 815, and 817. An input camera parameter received in operation 807 may be used to convert depth information received in operation 813 into disparity information in operation 812. The encoding apparatus may select (operation 808) an encoding mode from an intra prediction (operation 809), a motion prediction (operation 810), and a disparity prediction (operation 811).

The foregoing process may be applied to all frames included in the color image. In particular, the encoding apparatus may perform prediction to remove view redundancy and temporal redundancy, through intra prediction, motion prediction, and disparity prediction. In this instance, the encoding apparatus may convert depth information into disparity information based on a camera parameter, and may perform the disparity prediction.

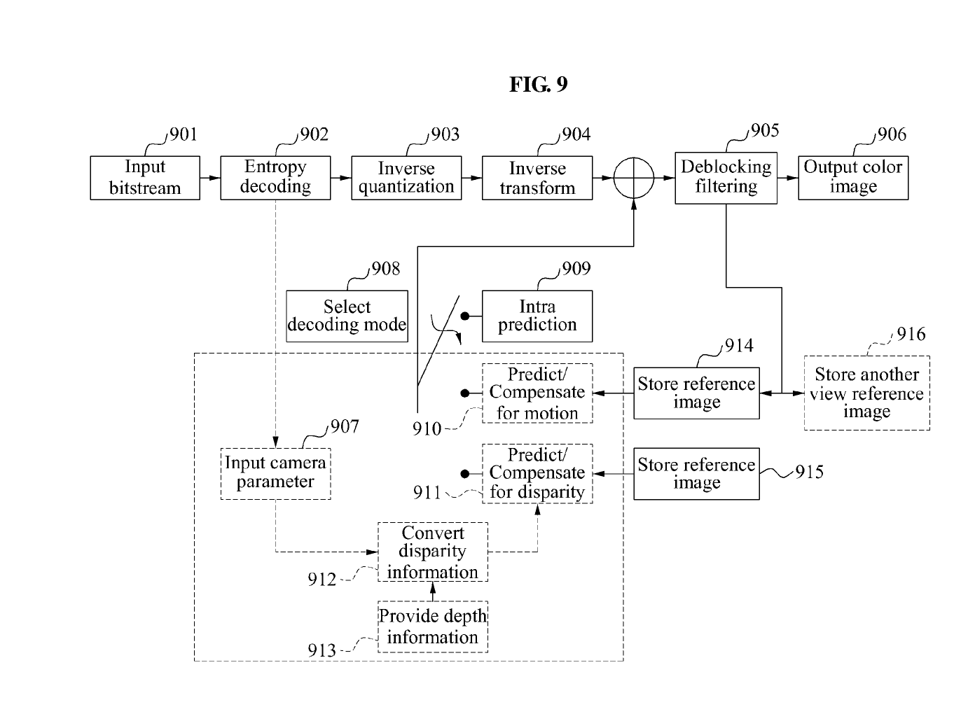

FIG. 9 illustrates a detailed operation of a decoding apparatus according to example embodiments.

The decoding apparatus may perform the inverse operation of the encoding apparatus of FIG. 8. The decoding apparatus may receive an input bitstream in operation 901, and may entropy decode the bitstream in operation 902. The decoding apparatus may perform inverse quantization on the decoded signal in operation 903, and inverse transform the inverse quantized signal in operation 904. In operation 905, the decoding apparatus may perform deblocking filtering based on the inverse transformed signal and the predictive image in order to precisely predict subsequent images. In operation 906, the decoding apparatus may output the color image obtained from the deblocking filtering.

The decoding apparatus may store a reference image in operations 914, 915, and 916. In operation 912, an input camera parameter received in operation 907 may be used to convert depth information received in operation 913 into disparity information. The decoding apparatus may select (operation 908) a decoding mode from an intra prediction (operation 909), a motion prediction (operation 910), and a disparity prediction (operation 911).

As a predictive image becomes similar to an original image, an amount of a residual signal may decrease and thus, a number of bits to be used for encoding may decrease as well. Accordingly, motion prediction and disparity prediction may be important.

According to the present example embodiments, view redundancy and temporal redundancy may be removed through vector prediction. In order to remove the temporal redundancy, motion vector prediction, that is, temporal prediction, may be performed. In order to remove the view redundancy, disparity vector prediction, that is, inter-view prediction, may be performed.

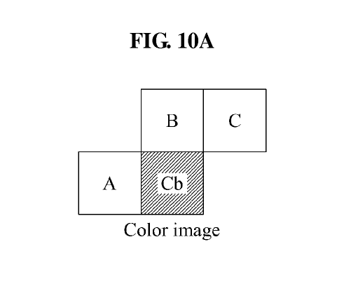

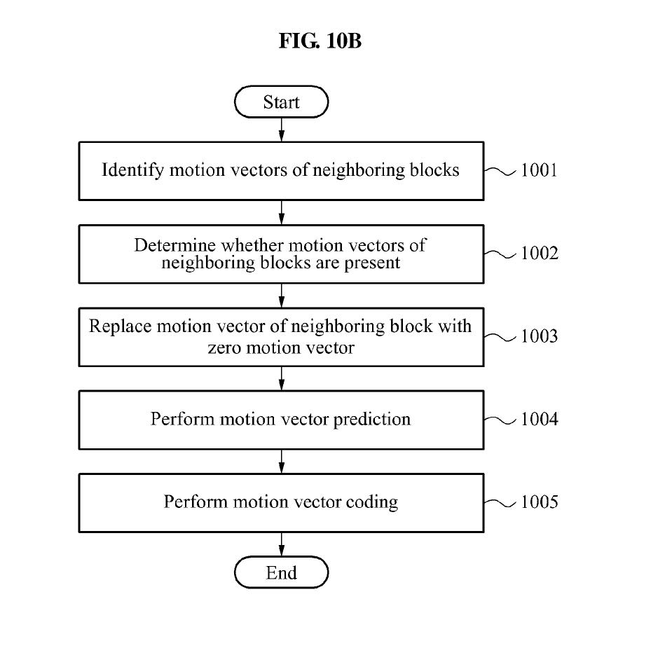

FIGS. 10A and 10B illustrate a process of predicting a motion vector of a current block according to example embodiments.

Referring to FIG. 10A, a current block to be coded in a color image corresponds to a block Cb. Neighboring blocks A, B, and C are present in locations adjacent to the current block Cb. An image processing apparatus may extract motion vectors of the neighboring blocks A, B, and C, respectively, and may apply a median filter to the extracted motion vectors, in order to predict a motion vector of the current block Cb.

When a motion vector of any one of the neighboring blocks A, B, and C is absent, the image processing apparatus may replace the motion vector of the corresponding block with a zero motion vector, and may apply the median filter to the zero motion vector and the extracted motion vectors.

A coding processing performed by estimating a motion vector will be described with reference to FIG. 10B.

In operation 1001, the image processing apparatus may identify the motion vectors of the neighboring blocks A, B, and C of the current block Cb. In operation 1002, the image processing apparatus may determine whether the motion vectors of the neighboring blocks are present. When a motion vector of any one of the neighboring blocks is absent, the image processing apparatus may replace the motion vector of the corresponding neighboring block with a zero motion vector, in operation 1003.

In operation 1004, the image processing apparatus may predict a motion vector of the current block Cb, by applying a median filter to the motion vectors of the neighboring blocks. In operation 1005, the image processing apparatus may perform motion vector coding, using a difference between a final motion vector and the predicted motion vector.

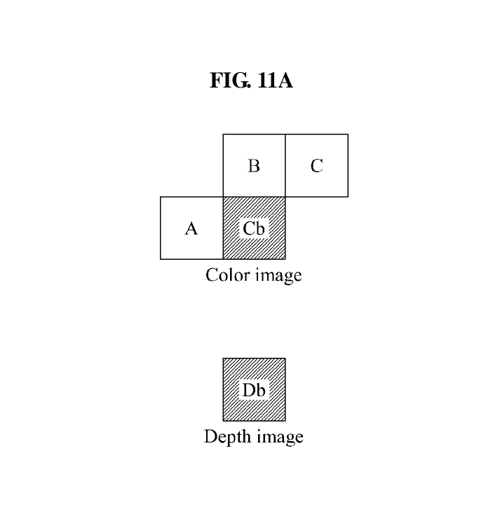

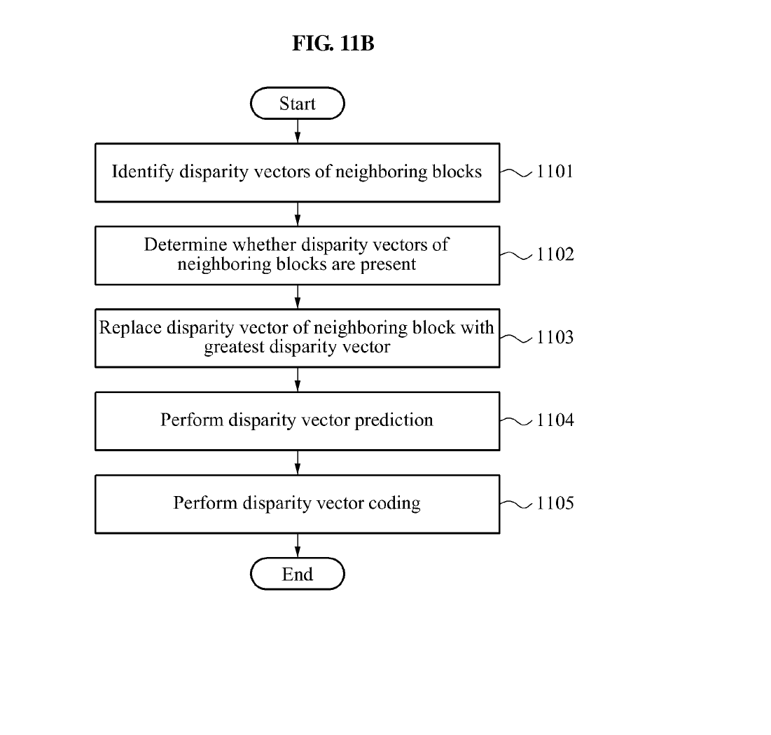

FIGS. 11A and 11B illustrate a process of predicting a disparity vector of a current block according to example embodiments.

Referring to FIG. 11A, a current block to be coded in a color image corresponds to a block Cb. Neighboring blocks A, B, and C are present in locations adjacent to the current block Cb. An image processing apparatus may extract disparity vectors of the neighboring blocks A, B, and C, respectively, and may apply a median filter to the extracted disparity vectors, in order to predict a disparity vector of the current block Cb.

When a disparity vector of any one of the neighboring blocks A, B, and C is absent, the image processing apparatus may replace the disparity vector of the corresponding block with a predetermined disparity vector. For example, when a disparity vector of the neighboring block A is absent, the image processing apparatus may convert a greatest depth value of a collocated block Db in a depth image corresponding to the current block Cb into a disparity vector. The image processing apparatus may replace the disparity vector of the neighboring block A with the converted disparity vector. The image processing apparatus may predict the disparity vector of the current block Cb, using the disparity vectors of the neighboring blocks A, B, and C.

In this instance, the image processing apparatus may use camera parameter information to convert a depth value into a disparity vector. The motion vector and the disparity vector of the current block Cb derived with reference to FIGS. 10A through 11B may be used as a predictive motion vector and a predictive disparity vector based on a 16×16 mode, a 16×8 mode, an 8×16 mode, and a P8×8 mode. The image processing apparatus may perform motion estimation and disparity estimation, using the predictive motion vector and the predictive disparity vector, thereby estimating a final motion vector and a final disparity vector of the current block Cb.

When a disparity vector of any one of the neighboring blocks A, B, and C is absent, the image processing apparatus may convert a greatest depth value among depth values of the collocated block Db in the depth image corresponding to the current block Cb, into the disparity vector. The image processing apparatus may replace the disparity vector of the corresponding neighboring block with the converted disparity vector. In inter-view prediction, predicting moving objects well may be useful. Because most moving objects may be positioned relatively close to a camera, when compared to a background, a moving object may have a greatest depth value. However, if the depth values are processed such that objects closer to the camera have a smaller depth value than objects farther from the camera, the moving object may have a smallest depth value among depth values. Accordingly, the image processing apparatus may convert a smallest depth value among depth values of the collocated block Db in the depth image corresponding to the current block Cb, into the disparity vector.

A coding processing performed by estimating a disparity vector will be described with reference to FIG. 11B.

In operation 1101, the image processing apparatus may identify disparity vectors of the neighboring blocks A, B, and C of the current block Cb. In operation 1102, the image processing apparatus may determine whether the disparity vectors of the neighboring blocks are present. When a disparity vector of any one of the neighboring blocks is absent, the image processing apparatus may replace the disparity vector of the corresponding neighboring block with a greatest disparity vector, in operation 1103. Here, the greatest disparity vector may refer to a disparity vector converted from a greatest depth value of the collocated block Db of the depth image corresponding to the current block Cb.

In operation 1104, the image processing apparatus may predict a disparity vector of the current block Cb, by applying a median filter to the disparity vectors of the neighboring blocks. In operation 1105, the image processing apparatus may perform disparity vector coding. The process described above may be performed according to the following scheme.

TABLE 1
If refIdxLX is a reference index to an inter-view reference component or an inter-view only
reference component, the depth-based derivation process for median luma motion vector
prediction in “Depth-based derivation process for median luma motion vector prediction” is
invoked with mbAddrN\mbPartIdxN\subMbPartIdxN, mvLXN, refIdxLXN with N being replaced
by A, B, or C, and refIdxLX as the inputs and the output is assigned to the motion vector
predictor mvpLX. // (Here, A, B, or C denotes a block disposed at the left corner, the top
corner, or the top-right corner of a current block, respectively, refIdxLX denotes a reference
index, mbAddrN denotes an address of a block N, mbPartIdxN denotes partition information
of the block N, and subMbPartIdxN denotes information about a sub-block of the block N. N =
A, B, or C)
Depth-based derivation process for median luma motion vector prediction
Inputs to this process are:
the neighboring partitions mbAddrN/mbPartIdxN/subMbPartIdxN (with N being replaced by
A, B, or C),
the motion vectors mvLXN (with N being replaced by A, B, or C) of the neighboring
partitions,
the reference indices refIdxLXN (with N being replaced by A, B, or C) of the neighboring
partitions,
the reference index refIdxLX of the current partition.
Output of this process is the motion vector prediction mvpLX.
When either partition mbAddrN\mbPartIdxN\subMbPartIdxN is not available or refIdxLXN is
not equal to refIdxLX, mvLXN is derived as specified by the following ordered steps:
1. The inverse macroblock scanning process is invoked with CurrMbAddr as the input and the
output is assigned to (x1, y1).
2. The inverse macroblock partition scanning process is invoked with mbPartIdx as the input
and the output assigned to (dx1, dy1).
3. The inverse sub-macroblock partition scanning process is invoked with mbPartIdx and
subMbPartIdx as the input and the output assigned to (dx2, dy2).
// ===> Steps 1 to 3 correspond to a process of determining an accurate location of the
current block.
4. The modification process of inter-view motion vector as specified in “Derivation process for
inter-view motion vector” is invoked with depthPic being equal to DepthRefPicList0[refIdxL0],
dbx1 being equal to x1 + dx1 + dx2, dby1 being equal to y1 + dy1 + dy2, and mv being equal
to mvL0 as inputs and the output is assigned to the motion vector mvLXN.
// ===> In step 4, a maximum disparity of a depth block corresponding to the current block
may be found. Here, the depth block may correspond to the collocated block described
above.
Each component of the motion vector prediction mvpLX is given by the median of the
corresponding vector components of the motion vector mvLXA, mvLXB, and mvLXC:
mvpLX[0] = Median(mvLXA[0], mvLXB[0], mvLXC[0])
mvpLX[1] = Median(mvLXA[1], mvLXB[1], mvLXC[1])
Derivation process for inter-view motion vector
Inputs to this process are
depth reference view component depthPic, // Depth block corresponding to the current
block
the location of a top-left sample (dbx1, dby1) of a partition, // a location of a first pixel of the
current block
a motion vector mv,
Outputs of this process are:
the motion vector mv.
Let refViewId be the view_id value of depthPic.
The following ordered steps apply:
1. Let numSamples be partWidth * partHeight.
2. The variable maxDepth is specified as follows:
maxDepth = INT_MIN
for(j = 0; j < partHeight; j++)
for(i = 0; i < partWidth; i++) if(
depthPic [dbx1 + i, dby1 + j] > maxDepth) maxDepth = depthPic[dbx1 + i, dby1 + j]
3. the variable mv is specified as follows:
index = ViewIdTo3DVAcquisitionParamIndex(view_id) // ID of a view in which the current
block is included.
refIndex = ViewIdTo3DVAcquisitionParamIndex(refViewId) // ID of a view in which an inter-
view reference is included.
mv[0] = Disparity(maxDepth, ZNear[frame_num, index], ZFar[frame_num, index],
FocalLengthX[frame_num, index], AbsTX[index] − AbsTX[refIndex])
mv[1] = 0

In addition to the process of replacing the disparity vector, the following example embodiments may be implemented.

In particular, the image processing apparatus may use a disparity vector converted from a greatest depth value of the collocated block Db of the depth image corresponding to the current block Cb, rather than using the disparity vectors of the neighboring blocks A, B, and C of the current block Cb. In this instance, the image processing apparatus may set the converted disparity vector to a predictive disparity vector of the current block Cb.

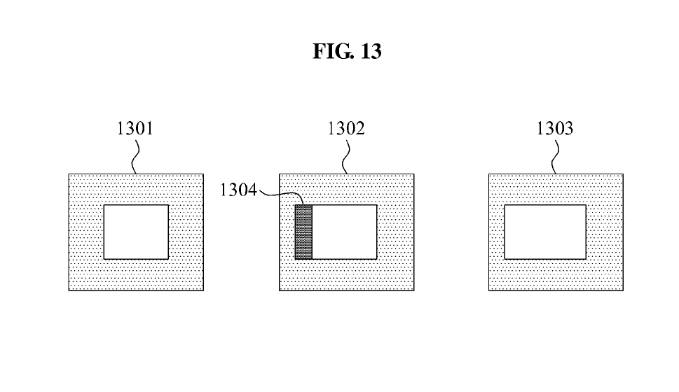

When the collocated block is to be used, there may be a case in which the depth image is absent. Such a case will be described with reference to FIG. 13.

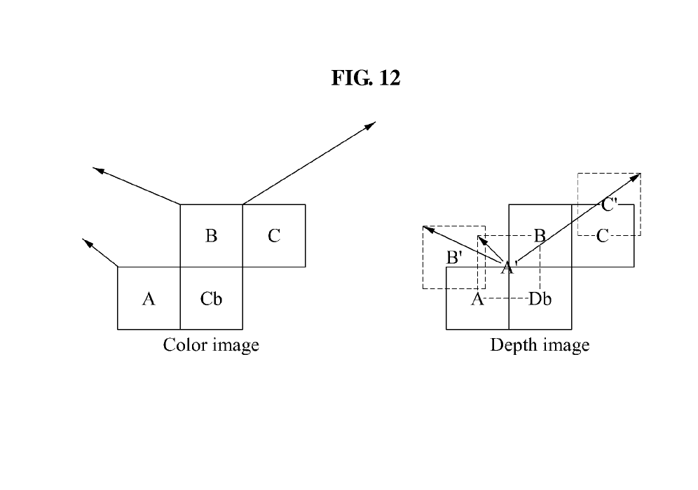

FIG. 12 illustrates a process of determining a final vector with respect to a skip mode and a direct mode of a current block according to example embodiments.

Referring to FIG. 12, a process of determining a final vector with respect to a skip mode and a direct mode of a current block Cb in a color image is illustrated. In particular, a process of performing coding based on the skip mode and the direct mode is illustrated. In the skip mode and the direct mode, motion search and disparity search may not be performed. Unlike a 16×16 mode, a 16×8 mode, an 8×16 mode, and a P8×8 mode, when an image processing apparatus obtains a final motion vector and a final disparity vector with respect to the skip mode or the direct mode of the current block Cb, the image processing apparatus may use motion vectors and disparity vectors of neighboring blocks of the current block Cb, and a collocated block Db of a depth image corresponding to the current block Cb.

Referring to FIG. 12, the image processing apparatus may convert, into disparity differences, differences between a depth value of the collocated block Db of the depth image and depth values of compensated blocks A′, B′, and C′ at locations indicated by motion vectors and disparity vectors of respective neighboring blocks, in the collocated block Db. In this instance, the image processing apparatus may determine a motion vector or a disparity vector associated with a compensated block having a smallest disparity difference, among the converted disparity differences, to be a final vector with respect to the skip mode or the direct mode of the current block Cb.

In this instance, when a difference between depth values is converted into a disparity vector, the image processing apparatus may use camera parameter information. Here, the camera may refer to a camera used to capture the depth image. A process of deriving a disparity difference, that is, an SAD-sum of absolute differences, may be expressed by Equation 1.

$$SAD = {\sum }_{y = 0 , x = 0}^{y < h , x < w} SAD ( Disp ( D ( Cb ) [ y , x ] ) , Disp ( D ( Cb , MVi ) [ y , x ] ) ) ) - ( 1 ) \\ SAD = {\sum }_{y = 0 , x = 0}^{y < h , x < w} Disparity ( SAD ( D ( Cb ) [ y , x ] ) , D ( Cb , MVi ) [ y , x ] ) ) - ( 2 ) \qquad [ Equation 1 ]$$

In Equation 1, D(Cb)[y,x] denotes a depth value at a location [y,x] of a collocated block in a depth image corresponding to a current block. D(Cb, MVi)[y,x] denotes a depth value at a location [y,x] of a compensated block at a location indicated by a motion vector or a disparity vector MVi of a neighboring block. In this instance, the depth value may refer to a depth value of a pixel at an identical location [y,x] between a neighboring block and a compensated block.

In addition, SAD(D(Cb)[y,x],D(Cb,MVi)[y,x]) denotes a difference between a depth value of a collocated block and a depth value of a compensated block. A disparity vector to be converted may be derived using Equation 2.

Disparity(SAD)=SAD*Coeff. [Equation 2]

In Equation 2, Disparity(SAD) denotes a disparity vector. SAD denotes a difference between a depth value of a neighboring block and a depth value of a compensated block. In addition, Coeff. denotes a predetermined constant or camera parameter information. Coeff. may be processed using Equation 3.

$$Coeff . = \frac{f \cdot l}{{2}^{bit}} \cdot ( \frac{1}{Znear} - \frac{1}{Zfar} ) \qquad [ Equation 3 ]$$

In Equation 3, bit denotes a bit-depth of a pixel at a camera, f denotes a focal length of the camera, l denotes a difference between base lines of the camera, Znear denotes a depth value of a pixel nearest to the camera, and Zfar denotes a depth value of a pixel farthest from the camera.

The process of FIG. 12 may be implemented using a shift operation >>, as follows.

TABLE 2
Inputs to this process are
sample arrays of decoded depth view components depthPic1 and depthPic2
// depthPic1 denotes a depth image block corresponding to the current block, and depthPic2
denotes a depth image block corresponding to a block at a location indicated by a motion
vector and a disparity vector. In particular, depthPic1 denotes a collocated block, and
depthPic2 denotes a compensated block.
the top-left corner [dbx1, dby1] of a block within depthPic1 and the top-left corner [dbx2,
dby2] of a block within depthPic2 // a location of a first pixel of each of depthPic1 and
depthPic2
the horizontal and vertical extents depth BlockWidth and depthBlockHeight a depth block
Output of this process is the disparity-based sum of absolute differences dispSumOfAbsDiff
converted from the sum of absolute differences between the depth blocks.
The variable dispSumOfAbsDiff is specified as follows.
index = ViewIdTo3DVAcquisitionParamIndex(view_id of the current view)
baseIndex = ViewIdTo3DVAcquisitionParamIndex(view_id of the base view)
dispCeoff = Max(round(log2(1/(FocalLengthX[frame_num, index] ÷ 255* (AbsTX[index] −
AbsTX[baseIndex]) ÷ 2*(1 ÷ ZNear[frame_num, index] − 1 ÷ ZFar[frame_num, index])), 0) //
Log2 may be selected in order to use an Integer operation shift >> instead of division
corresponding to a Floating operation.
dispSumOfAbsDiff = 0
for(j = 0; j < depthBlockHeight; j++)
for(i = 0; i < depthBlockWidth; i++)
dispSumOfAbsDiff += Abs(depthPic1[dbx1 + i, dby1 + j] − depthPic2[dbx2 + i, dby1 + j])
>>dispCoeff

Thus, the image processing apparatus may convert, into disparity differences indicating disparity vectors, differences between pixels in the collocated block of the depth image corresponding to the current block and pixels in the compensated block positioned at a location indicated by a motion vector and a disparity vector of a neighboring block in the depth image.

FIG. 13 illustrates a process of estimating a depth image according to example embodiments.

As described above, a depth image corresponding to a current block may be necessary in order to derive a collocated block and a compensated block. However, depending on conditions, the depth image may be absent.

The image processing apparatus may estimate a depth image corresponding to the current block, using color images or depth images that are positioned adjacent to a color image including the current block, in terms of time or point of view. In addition, when a hole pixel generated in a form of a hole or a hole pixel undefined is present because a predetermined pixel fails to be estimated in a block included in the estimated depth image, the image processing apparatus may replace a pixel value of the hole pixel with a pixel value of an adjacent pixel having a greatest pixel value, among adjacent pixels of the hole pixel. As another example, when a hole pixel generated in a form of a hole or an undefined hole pixel is absent because a predetermined pixel fails to be estimated in a block included in the estimated depth image, the image processing apparatus may replace a pixel value of the hole pixel with an interpolation value obtained by interpolating the adjacent pixels of the hole pixel.

Referring to FIG. 13, a depth image 1301 may refer to a depth image positioned adjacent to a color image including a current block, in terms of time or point of view. A depth image 1302 may refer to a depth image estimated based on the depth image 1301. In this instance, the estimated depth image 1302 may include an undefined hole pixel 1304.

The image processing apparatus may replace a pixel value of the undefined hole pixel 1304 with a pixel value of an adjacent pixel having a greatest pixel value, among adjacent pixels of the undefined hole pixel 1304. When the adjacent pixel having the greatest pixel value in the depth image indicates a white color, the undefined hole pixel 1304 may be filled with the white color, as shown in a depth image 1303. For another example, the image processing apparatus may replace the pixel value of the undefined hole pixel 1304 with an interpolation value, by interpolating the adjacent pixels of the undefined hole pixel 1304.

As described with reference to FIG. 12, the image processing device may determine a final vector of the current block, using a collocated block or a compensated block that is present in the estimated depth image.

Accordingly, a disparity vector to be used to search for a block corresponding to the current block in another view image may be replaced with a disparity vector converted from a greatest value, among values of a depth block corresponding to the current block.

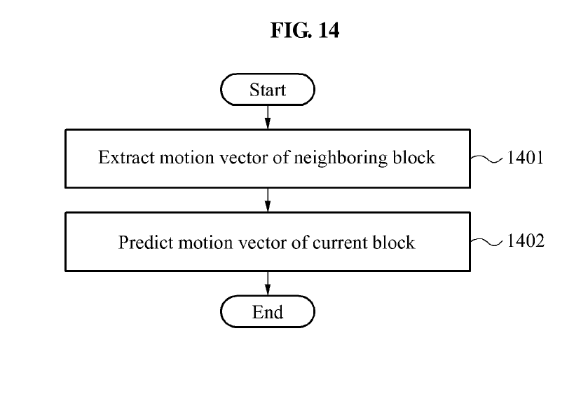

FIG. 14 illustrates an image processing method according to example embodiments.

Referring to FIG. 14, in operation 1401, an image processing apparatus may extract a motion vector of at least one neighboring block with respect to a current block of a color image to be coded. For example, the image processing apparatus may replace the motion vector of the at least one neighboring block with a zero motion vector when a motion vector of the at least one neighboring block is absent. Here, the neighboring block may refer to an encoded or decoded block neighboring the current block at the top corner, the top-right corner, or the left corner of the current block, in the color image.

In operation 1402, the image processing apparatus may predict a motion vector of the current block, using the motion vector of the at least one neighboring block. For example, the image processing apparatus may predict the motion vector of the current block by applying a median filter to the motion vector of the at least one neighboring block.

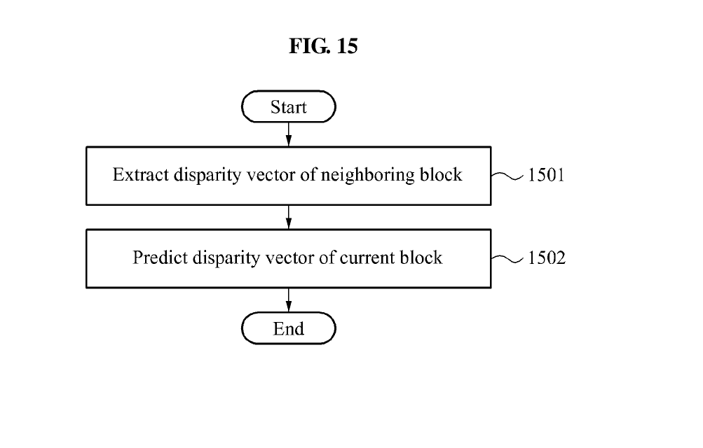

FIG. 15 illustrates an image processing method according to example embodiments.

Referring to FIG. 15, in operation 1501, an image processing apparatus may extract a disparity vector of at least one neighboring block with respect to a current block of a color image to be coded. Here, the neighboring block may refer to an encoded or decoded block neighboring the current block at the top corner, the top-right corner, or the left corner of the current block, in the color image. When a neighboring block is absent at the top-right corner of the current block, the image processing apparatus may use a neighboring block positioned at the top-left corner of the current block.

For example, when a disparity vector of the at least one neighboring block is absent, the image processing apparatus may extract the disparity vector of the at least one neighboring block, using a collocated block of a depth image corresponding to the current block. In particular, when a disparity vector of the at least one neighboring block is absent, the image processing apparatus may replace the disparity vector of the at least one neighboring block with a disparity vector converted from a greatest depth value of the collocated block of the depth image. The collocated block may include a block positioned at an identical location of the current block, in the depth image corresponding to the color image. Here, a size of the depth image corresponding to the current block may be the same as a size of the color image, or the size of the depth image may differ from the size of the color image.

When a depth image corresponding to the current block is absent, the image processing apparatus may estimate a depth image corresponding to the current block, using a neighboring depth image or a neighboring color image of the color image including the current block. In this instance, the image processing apparatus may replace a hole pixel undefined in the estimated depth image corresponding to the current block with an adjacent pixel having a greatest pixel value, among adjacent pixels. As another example, the image processing apparatus may replace a pixel value of the hole pixel undefined in the estimated depth image corresponding to the current block with an interpolation value obtained by interpolating the adjacent pixels of the hole pixel.

In operation 1502, the image processing apparatus may predict a disparity vector of the current block, using the disparity vector of the at least one neighboring block.

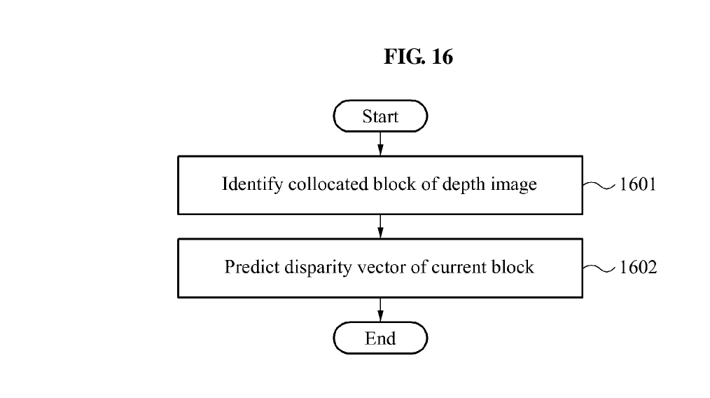

FIG. 16 illustrates an image processing method according to example embodiments.

Referring to FIG. 16, in operation 1601, an image processing apparatus may identify a collocated block of a depth image corresponding to a current block of a color image to be coded. For example, the image processing apparatus may identify a collocated block of a depth image corresponding to a point of view identical to or different from a point of view of the color image. Here, the collocated block may include a block positioned at an identical location of the current block, in the depth image corresponding to the color image. In this instance, a size of the depth image corresponding to the current block may be the same as a size of the color image, or the size of the depth image may differ from the size of the color image.

When a depth image corresponding to the current block is absent, the image processing apparatus may estimate a depth image corresponding to the current block, using a neighboring depth image or a neighboring color image of the color image including the current block. In this instance, the image processing apparatus may replace a hole pixel undefined in the estimated depth image corresponding to the current block with an adjacent pixel having a greatest pixel value, among adjacent pixels. As another example, the image processing apparatus may replace a pixel value of the hole pixel undefined in the estimated depth image corresponding to the current block with an interpolation value obtained by interpolating the adjacent pixels of the hole pixel.

The image processing apparatus may predict a disparity vector of the current block, by converting a greatest depth value of the collocated block of the depth image into a disparity value.

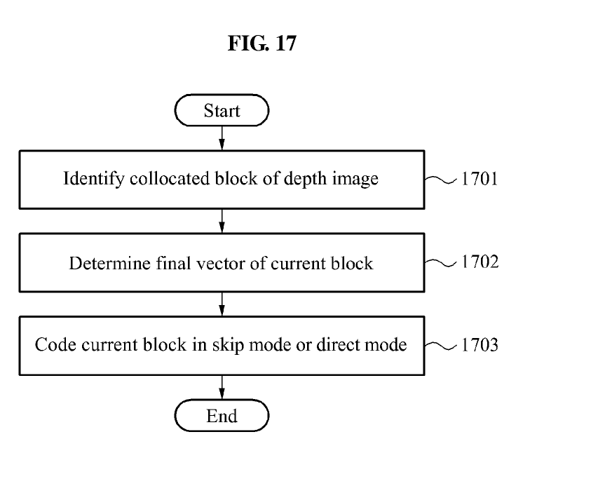

FIG. 17 illustrates an image processing method according to example embodiments.

Referring to FIG. 17, in operation 1701, an image processing apparatus may identify at least one neighboring block of a current block of a color image, and a collocated block of a depth image corresponding to the current block. Here, a size of the depth image may be the same as a size of the color image, or the size of the depth image may differ from the size of the color image.

In operation 1702, the image processing unit may determine a final vector with respect to a skip mode or a direct mode of the current block, based on the at least one neighboring block and the collocated block. For example, the image processing apparatus may determine compensated blocks, based on a motion vector or a disparity vector of the at least one neighboring block, in the collocated block. The image processing apparatus may compare a depth value of the collocated block to depth values of respective compensated blocks. The image processing apparatus convert differences between the depth value of the collocated block and the depth values of respective compensated blocks into disparity differences, and may use a motion vector or a disparity vector of a neighboring block having a smallest disparity difference, among the disparity differences.

In operation 1703, the image processing apparatus may code the current block in the skip mode or the direct mode, using the final vector of the current block.

The method according to the above-described embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing method, comprising:
extracting a motion vector of at least one neighboring block with respect to a current block of a color image to be coded; and
predicting a motion vector of the current block, using the extracted motion vector of the at least one neighboring block.

2. The method of claim 1, wherein the extracting comprises replacing the motion vector of the at least one neighboring block with a zero motion vector when the motion vector of the at least one neighboring block is absent.

3. The method of claim 1, wherein the predicting comprises predicting the motion vector of the current block by applying a median filter to the extracted motion vector of the at least one neighboring block.

4. An image processing method, comprising:
extracting a disparity vector of at least one neighboring block with respect to a current block of a color image to be coded; and
predicting a disparity vector of the current block, using the extracted disparity vector of the at least one neighboring block.

5. The method of claim 4, wherein the extracting comprises extracting the disparity vector of the at least one neighboring block, using a collocated block of a depth image corresponding to the current block when the disparity vector of the at least one neighboring block is absent.

6. The method of claim 5, wherein a size of the depth image is the same as a size of the color image, or the size of the depth image differs from the size of the color image.

7. The method of claim 5, wherein the extracting comprises replacing the disparity vector of the at least one neighboring block with a disparity vector converted from a greatest depth value of the collocated block when the disparity vector of the at least one neighboring block is absent.

8. The method of claim 5, wherein the collocated block comprises a collocated block of a depth image corresponding to the color image.

9. The method of claim 5, wherein the extracting comprises estimating the depth image corresponding to the current block using a neighboring depth image or a neighboring color image of the color image including the current block when the depth image corresponding to the current block is absent.

10. The method of claim 9, wherein the extracting comprises replacing a hole pixel undefined in the estimated depth image corresponding to the current block with an adjacent pixel having a greatest pixel value, among adjacent pixels of the hole pixel.

11. The method of claim 9, wherein the extracting comprises replacing a pixel value of a hole pixel undefined in the estimated depth image corresponding to the current block with an interpolation value obtained by interpolating adjacent pixels of the hole pixel.

12. An image processing method, comprising:
identifying a collocated block of a depth image corresponding to a current block of a color image to be coded; and
predicting a disparity vector of the current block, by converting a greatest depth value of the collocated block into a disparity value.

13. The method of claim 12, wherein the identifying comprises identifying a collocated block of a depth image corresponding to the color image.

14. The method of claim 12, wherein a size of the depth image is the same as a size of the color image, or the size of the depth image differs from the size of the color image.

15. The method of claim 12, wherein the identifying comprises estimating the depth image corresponding to the current block using a neighboring depth image or a neighboring color image of the color image including the current block when the depth image corresponding to the current block is absent.

16. The method of claim 15, wherein the identifying comprises replacing a hole pixel undefined in the estimated depth image corresponding to the current block with an adjacent pixel having a greatest pixel value, among adjacent pixels of the hole pixel.

17. The method of claim 15, wherein the identifying comprises replacing a pixel value of a hole pixel undefined in the estimated depth image corresponding to the current block with an interpolation value obtained by interpolating adjacent pixels of the hole pixel.

18. An image processing method, comprising:
identifying at least one neighboring block of a current block of a color image, and a collocated block of a depth image corresponding to the current block;
determining a final vector with respect to a skip mode or a direct mode of the current block, based on the at least one neighboring block and the collocated block; and
coding the current block in the skip mode or the direct mode, using the final vector of the current block.

19. The method of claim 18, wherein the determining comprises:
determining compensated blocks, based on a motion vector or a disparity vector of the at least one neighboring block, in the collocated block; and
comparing a depth value of the collocated block to depth values of the respective compensated blocks.

20. The method of claim 19, wherein the determining comprises converting differences between the depth value of the collocated block and the depth values of the respective compensated blocks into disparity differences, and determining a smallest disparity difference among the disparity differences to be the motion vector or the disparity vector of the at least one neighboring block.

21. The method of claim 19, wherein the determining comprises converting differences between the depth value of the collocated block and the depth values of the respective compensated blocks into disparity differences, using a parameter of a camera used to capture the depth image.

22. An image processing apparatus, comprising:
a motion vector extracting unit to extract a motion vector of at least one neighboring block with respect to a current block of a color image to be coded; and
a motion vector predicting unit to predict a motion vector of the current block, using the extracted motion vector of the at least one neighboring block.

23. The apparatus of claim 22, wherein the motion vector extracting unit replaces the motion vector of the at least one neighboring block with a zero motion vector when the motion vector of the at least one neighboring block is absent.

24. An image processing apparatus, comprising:
a disparity vector extracting unit to extract a disparity vector of at least one neighboring block with respect to a current block of a color image to be coded; and
a disparity vector predicting unit to predict a disparity vector of the current block, using the extracted disparity vector of the at least one neighboring block.

25. The apparatus of claim 24, wherein the disparity vector extracting unit extracts the disparity vector of the at least one neighboring block, using a collocated block of a depth image corresponding to the current block when the disparity vector of the at least one neighboring block is absent.

26. The apparatus of claim 25, wherein a size of the depth image is the same as a size of the color image, or the size of the depth image differs from the size of the color image.

27. The apparatus of claim 25, wherein the disparity vector extracting unit replaces the disparity vector of the at least one neighboring block with a disparity vector converted from a greatest depth value of the collocated block when the disparity vector of the neighboring block is absent.

28. The apparatus of claim 25, wherein the collocated block comprises a collocated block of a depth image corresponding to the color image.

29. The apparatus of claim 25, wherein the disparity vector extracting unit estimates a depth image corresponding to the current block using a neighboring depth image or a neighboring color image of the color image including the current block when the depth image corresponding to the current block is absent.

30. The apparatus of claim 29, wherein the disparity vector extracting unit replaces a hole pixel undefined in the estimated depth image corresponding to the current block with an adjacent pixel having a greatest pixel value, among adjacent pixels of the hole pixel.

31. The apparatus of claim 30, wherein the disparity vector extracting unit replaces a pixel value of a hole pixel undefined in the estimated depth image corresponding to the current block with an interpolation value obtained by interpolating adjacent pixels of the hole pixel.

32. An image processing apparatus, comprising:
a collocated block identifying unit to identify a collocated block of a depth image corresponding to a current block of a color image to be coded; and
a disparity vector predicting unit to predict a disparity vector of the current block, by converting a greatest depth value of the collocated block into a disparity value.

33. The apparatus of claim 32, wherein the collocated block identifying unit identifies a collocated block of a depth image corresponding to the color image.

34. The apparatus of claim 32, wherein a size of the depth image is the same as a size of the color image, or the size of the depth image differs from the size of the color image.

35. The apparatus of claim 32, wherein the collocated block identifying unit estimates a depth image corresponding to the current block using a neighboring depth image or a neighboring color image of the color image including the current block when a depth image corresponding to the current block is absent.

36. The apparatus of claim 32, wherein the collocated block identifying unit replaces a hole pixel undefined in the estimated depth image corresponding to the current block with an adjacent pixel having a greatest pixel value, among adjacent pixels of the hole pixel.

37. The apparatus of claim 32, wherein the collocated block identifying unit replaces a pixel value of a hole pixel undefined in the estimated depth image corresponding to the current block with an interpolation value obtained by interpolating adjacent pixels of the hole pixel.

38. An image processing apparatus, comprising:
a collocated block identifying unit to identify at least one neighboring block of a current block of a color image, and a collocated block of a depth image corresponding to the current block;
a final vector determining unit to determine a final vector with respect to a skip mode or a direct mode of the current block, based on the at least one neighboring block and the collocated block; and
an image coding unit to code the current block in the skip mode or the direct mode, using the final vector of the current block.

39. The apparatus of claim 38, wherein the final vector determining unit determines compensated blocks, based on a motion vector or a disparity vector of the at least one neighboring block, in the collocated block, and compares a depth value of the collocated block to depth values of the respective compensated blocks.

40. The apparatus of claim 39, wherein the final vector determining unit converts differences between the depth value of the collocated block and the depth values of the respective compensated blocks into disparity differences, and determines a smallest disparity difference among the disparity differences to be the motion vector or the disparity vector of the at least one neighboring block.

41. The apparatus of claim 40, wherein the final vector determining unit converts a difference between the depth value of the collocated block and the depth values of the respective compensated blocks into disparity differences, using a parameter of a camera used to capture the depth image.

42. A non-transitory computer-readable medium comprising a program for instructing a computer to perform the method of claim 1.

43. An image processing method, comprising:
extracting at least one of a motion vector and a disparity vector of at least one neighboring block with respect to a current block of a color image to be coded; and
predicting at least one of a motion vector and a disparity vector of the current block, using the extracted vector of the at least one neighboring block.

44. A method for compressing a residual signal between a current block positioned in a current frame corresponding to a current image, and a predictive block, the method comprising:
searching for the predictive block most similar to the current block in at least a first reference image, a second reference image, a third reference image, and a fourth reference image,
wherein the first reference image and second reference image are positioned adjacent to the current frame in terms of time, and the third reference image and the fourth reference image are positioned adjacent to the current frame in terms of point of view.
